(19) United States
(12) Patent Application Publication
(10) Pub. No.: US 2026/0246095 A1
(43) Pub. Date: Aug. 20, 2026

(54) BUSBAR ASSEMBLY AND BATTERY PACK INCLUDING THE SAME

(71) Applicant: SAMSUNG SDI CO., LTD., Yongin-si, Gyeonggi-do (KR)

(72) Inventor: Sang Hun PARK, Suwon-si (KR)

(21) Appl. No.: 19/279,295

(22) Filed: Jul. 24, 2025

(30) Foreign Application Priority Data
Feb. 18, 2025 (KR) 10-2025-0020889

(51) Int. Cl. H01M 50/503; H01M 50/213; H01M 50/507; H01M 50/509; H01M 50/519

(52) U.S. Cl. CPC H01M 50/503; H01M 50/213; H01M 50/507; H01M 50/509; H01M 50/519

(57) ABSTRACT

A busbar assembly includes a first electrode parallel busbar configured to connect first electrode terminals of a plurality of first electrode end battery cells among a plurality of battery cells, each one of the battery cells including a first electrode terminal of the first electrode terminals and a second electrode terminal of the second electrode terminals; a second electrode parallel busbar configured to connect the second electrode terminals of a plurality of second electrode end battery cells among the plurality of battery cells; and a series-parallel busbar configured to connect the second electrode terminals of the plurality of battery cells of which the first electrode terminals are connected together among the plurality of battery cells and the first electrode terminals of the plurality of battery cells of which the second electrode terminals are connected together among the plurality of battery cells.

### CROSS REFERENCE TO RELATED APPLICATION

The present application claims priority to and the benefit of Korean Patent Application No. 10-2025-0020889, filed on Feb. 18, 2025, in the Korean Intellectual Property Office, the entire disclosure of which is incorporated herein by reference.

### BACKGROUND

### 1. Field Disclosure

Aspects of the present disclosure relate to a busbar assembly and a battery pack including the same.

### 2. Description of the Related Art

A secondary battery is a battery that can be charged and discharged, unlike a primary battery that cannot be recharged. A small-capacity secondary battery is used for portable small electronic devices such as smartphones, feature phones, laptop computers, digital cameras, and camcorders, and a large-capacity secondary battery is widely used as, for example, a power supply for driving a motor for a hybrid vehicle, an electric vehicle, or the like, and a battery for storing power. Such a secondary battery includes an electrode assembly that includes a positive electrode and a negative electrode, a case that accommodates the electrode assembly, and an electrode tab that is connected to the electrode assembly.

In order to increase a voltage and capacity of the secondary battery, a plurality of battery cells may be connected in series and/or in parallel. A busbar is used to connect the battery cells in series and/or in parallel, and there is a difference in height between a location where a positive electrode is disposed and a location where a negative electrode is disposed in the battery cell.

The above information disclosed in this Background section is provided for enhancement of understanding of the background of the present disclosure, and, therefore, it may contain information that does not constitute related (or prior) art.

### SUMMARY DISCLOSURE

Aspects of the present disclosure are directed to providing a busbar assembly and a battery pack capable of compensating for a difference in height between a positive electrode terminal and a negative electrode terminal of a battery cell.

These and other aspects and features of the present disclosure will be described in or will be apparent from the following description of some embodiments of the present disclosure.

According to some embodiments of the present disclosure, there is provided a busbar assembly including: a first electrode parallel busbar configured to connect first electrode terminals of a plurality of first electrode end battery cells among a plurality of battery cells, each one of the battery cells including a first electrode terminal of the first electrode terminals and a second electrode terminal of the second electrode terminals; a second electrode parallel busbar configured to connect the second electrode terminals of a plurality of second electrode end battery cells among the plurality of battery cells; and a series-parallel busbar configured to connect the second electrode terminals of the plurality of battery cells of which the first electrode terminals are connected together among the plurality of battery cells and the first electrode terminals of the plurality of battery cells of which the second electrode terminals are connected together among the plurality of battery cells.

In some embodiments, the series-parallel busbar is connected to the second electrode terminals of the first electrode end battery cells.

In some embodiments, the series-parallel busbar is connected to the first electrode terminals of the second electrode end battery cells.

In some embodiments, the series-parallel busbar includes a first series-parallel busbar and a second series-parallel busbar, and the first series-parallel busbar connects together the first electrode terminals of the battery cells of which the second electrode terminals are connected together by the second series-parallel busbar.

In some embodiments, the first electrode parallel busbar, the second electrode parallel busbar, and the series-parallel busbar include a board contact portion connected to a circuit board.

In some embodiments, the first electrode parallel busbar and the series-parallel busbar include a first electrode terminal contact portion that is in contact with the first electrode terminal and includes a first metal, and the second electrode parallel busbar and the series-parallel busbar include a second electrode terminal contact portion that is in contact with the second electrode terminal and includes a second metal different from the first metal.

In some embodiments, at least one of the first electrode parallel busbar, the second electrode parallel busbar, and the series-parallel busbar includes: a busbar body; and a bending portion in the busbar body and formed to be bent between one side of the bending portion and an other side of the bending portion.

In some embodiments, a height of one side of the bending portion is different from a height of the other side of the bending portion.

In some embodiments, the bending portion further includes: a bending bridge on the busbar body and formed to be concave; and a bending slit formed as a hole passing through the bending bridge.

In some embodiments, the first electrode parallel busbar connects the first electrode end battery cells together, the second electrode parallel busbar connects the second electrode end battery cells together, and the series-parallel busbar connects the battery cells in parallel.

According to some embodiments of the present disclosure, there is provided a battery pack including: a holder part including a lower holder and an upper holder; a first group battery cell between the lower holder and the upper holder and including a plurality of battery cells each including a first electrode terminal and a second electrode terminal; and a first busbar assembly disposed in the upper holder to electrically connect the battery cells in the first group battery cell, wherein the first busbar assembly includes: a first electrode parallel busbar configured to connect the first electrode terminals of a plurality of first electrode end battery cells among the plurality of battery cells together; a second electrode parallel busbar configured to connect the second electrode terminals of a plurality of second electrode end battery cells among the plurality of battery cells together; and a series-parallel busbar configured to connect the second electrode terminals of the plurality of battery cells of which the first electrode terminals are connected together among the plurality of battery cells, and the first electrode terminals of the plurality of battery cells of which the second electrode terminals are connected together among the plurality of battery cells.

In some embodiments, the battery pack further includes: a second group battery cell between the lower holder and the upper holder and including a plurality of battery cells each including a first electrode terminal and a second electrode terminal; and a second busbar assembly in the upper holder to electrically connect the battery cells of the second group battery cell and including a first electrode parallel busbar, a second electrode parallel busbar, and a series-parallel busbar.

In some embodiments, the battery pack further includes: a circuit board in the upper holder and including a circuit board connection portion to which the first busbar assembly and the second busbar assembly are connected, and configured to connect the first busbar assembly and the second busbar assembly in series.

In some embodiments, the upper holder includes: an upper holder body; and an upper holder seating recess formed as a concave recess in the upper holder body in which the first busbar assembly and the second busbar assembly are positioned.

In some embodiments, the upper holder further includes an upper holder seating projection in the upper holder seating recess, protruding from the upper holder body, and inserted into a bending recess portion formed to be concave in the first busbar assembly or the second busbar assembly.

In some embodiments, the upper holder includes: an upper holder body; and an upper holder terminal hole that passes through the upper holder body and exposes one of the battery cells.

In some embodiments, at least one of the first electrode parallel busbar, the second electrode parallel busbar, and the series-parallel busbar includes: a busbar body; and a bending portion disposed in the busbar body and formed to be bent between one side and an other side of the bending portion.

In some embodiments, a height of one side of the bending portion is different from a height of the other side of the bending portion.

In some embodiments, the bending portion further includes: a bending bridge on the busbar body and formed to be concave; and a bending slit formed as a hole passing through the bending bridge.

In some embodiments, the first electrode parallel busbar connects the first electrode end battery cells together, wherein the second electrode parallel busbar connects the second electrode end battery cells together, and wherein the series-parallel busbar connects the battery cells in parallel.

However, the effects obtainable through the present disclosure are not limited to the above effects, and other technical effects that are not mentioned will be clearly understood by those skilled in the art from the following description of the present disclosure.

### BRIEF DESCRIPTION OF THE DRAWINGS

The drawings attached to this specification illustrate some embodiments of the present disclosure, and further describe aspects and features of the present disclosure together with the detailed description of the present disclosure. However, the present disclosure should not be construed as being limited to the drawings:

FIG. 1 is a perspective view schematically illustrating a configuration of a battery pack according to some embodiments of the present disclosure;

FIG. 2 is an exploded perspective view schematically illustrating the configuration of the battery pack according to some embodiments of the present disclosure;

FIG. 3 is a plan view of a portion of a battery pack according to some embodiments of the present disclosure;

FIG. 4 is a perspective view of a battery cell according to some embodiments of the present disclosure;

FIG. 5 is a cross-sectional view schematically illustrating a configuration of the battery cell according to some embodiments of the present disclosure;

FIG. 6 is a cross-sectional view schematically illustrating a configuration of the battery cell according to some embodiments of the present disclosure;

FIG. 7 is a perspective view of a holder part, a busbar assembly, and a circuit board according to some embodiments of the present disclosure;

FIG. 8 is an exploded perspective view of the holder part, the busbar assembly, and the circuit board according to some embodiments of the present disclosure;

FIG. 9 is a perspective view of the circuit board and the busbar assembly according to some embodiments of the present disclosure;

FIG. 10 is a cross-sectional perspective view of a portion of the holder part and the battery cell according to some embodiments of the present disclosure;

FIG. 11 is a cross-sectional perspective view of a portion of the holder part and the busbar assembly according to some embodiments of the present disclosure;

FIG. 12 is a plan view of a first electrode parallel busbar according to some embodiments of the present disclosure;

FIG. 13 is a plan view of a second electrode parallel busbar according to some embodiments of the present disclosure;

FIG. 14 is a plan view of a series-parallel busbar according to some embodiments of the present disclosure;

FIG. 15 is a perspective view of a first electrode terminal contact portion according to some embodiments of the present disclosure;

FIG. 16 is a perspective view of the first electrode terminal contact portion according to some other embodiments of the present disclosure;

FIG. 17 is a perspective view of the first electrode terminal contact portion according to still other embodiments of the present disclosure;

FIG. 18 is a perspective view of a bending portion of a busbar assembly according to some embodiments of the present disclosure;

FIG. 19 is a perspective view of the bending portion of a busbar assembly according to some other embodiments of the present disclosure; and

FIG. 20 is a perspective view of a bending portion of the busbar assembly according to still other embodiments of the present disclosure.

### DETAILED DESCRIPTION

Herein, some embodiments of the present disclosure will be described, in further detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term.

The embodiments described in this specification and the configurations shown in the drawings are provided as some example embodiments of the present disclosure and do not represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same or like elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being disposed (or located or positioned) on the “above (or below)” or “on (or under)” a component, it may mean that the arbitrary element is placed in contact with the upper (or lower) surface of the component and may also mean that another component may be interposed between the component and any arbitrary element disposed (or located or positioned) on (or under) the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part or one or more intervening parts may be present therebetween such that the part and the another part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

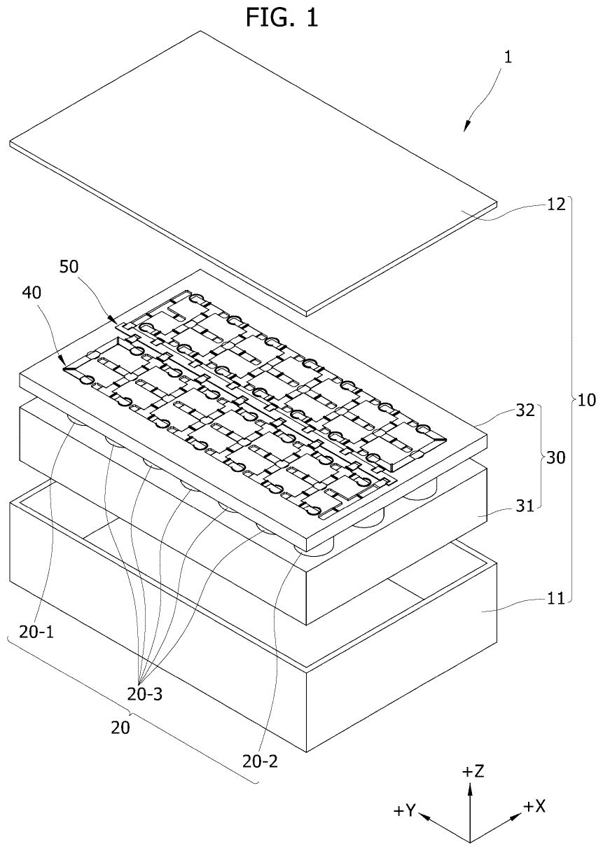

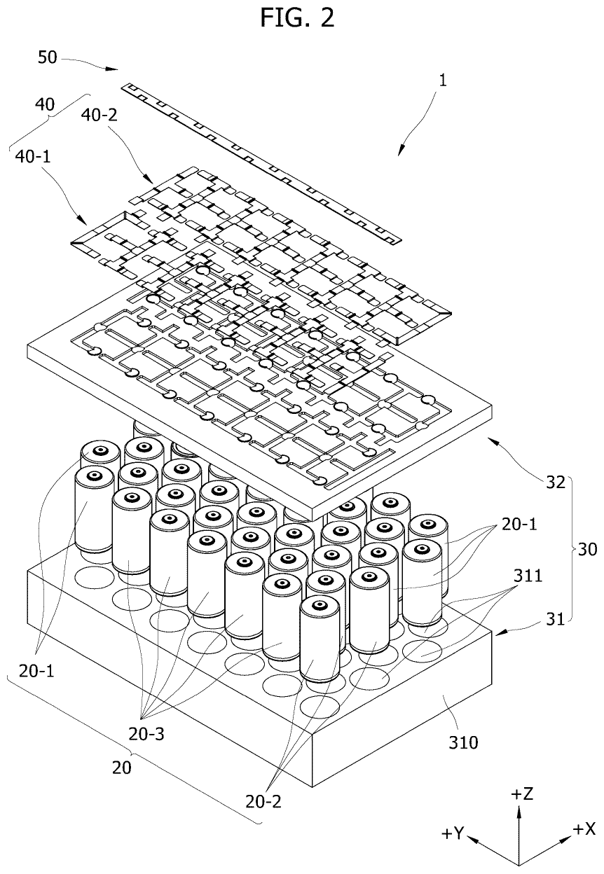

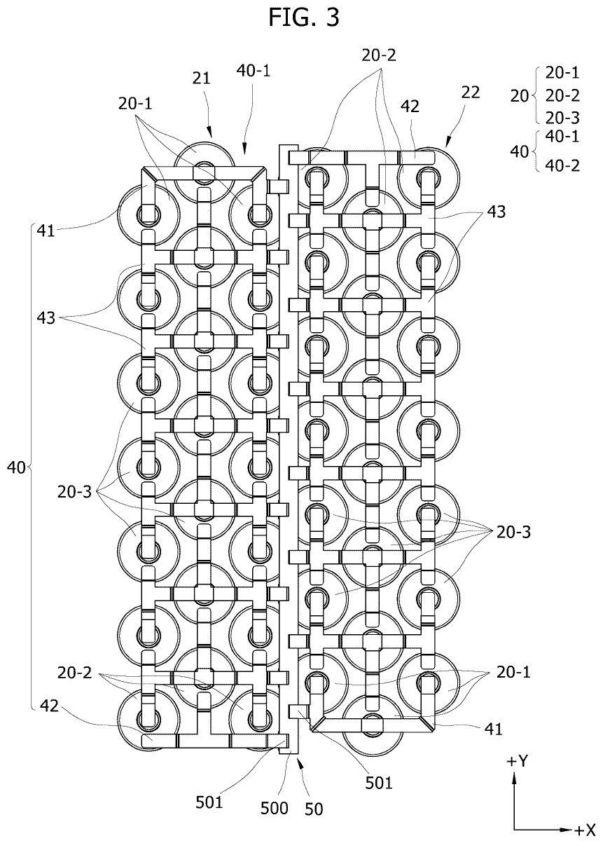

FIG. 1 is a perspective view schematically illustrating a configuration of a battery pack according to some embodiments of the present disclosure. FIG. 2 is an exploded perspective view schematically illustrating a configuration of a battery pack according to some embodiments of the present disclosure. FIG. 3 is a plan view of a portion of a battery pack according to some embodiments of the present disclosure.

Referring to FIGS. 1 to 3, a battery pack 1 according to some embodiments may include a housing 10, a battery cell 20, a holder part 30, a busbar assembly 40, and a circuit board 50.

The housing 10 may form a schematic exterior of the battery pack 1 and provide a space in which the battery cell 20 may be accommodated. According to some embodiments, a plurality of battery cells 20 may be accommodated in the housing 10.

The housing 10 according to some embodiments may include a housing body 11 and a housing cover 12.

The housing body 11 may be formed to have the shape of a box with a hollow interior and an open side. However, the cross-sectional shape of the housing body 11 is not limited to the square illustrated in FIG. 1 and may be designed to have various suitable shapes such as a polygon, a circle, and an oval.

A first direction to be described below may be defined as a direction parallel to a Y-axis in FIG. 1 as a longitudinal direction of the housing body 11, a width direction of the housing body 11 may be defined as a direction parallel to an X-axis in FIG. 1, and a height direction of the housing body 11 may be defined as a direction parallel to a Z-axis in FIG. 1.

The housing cover 12 may be coupled to the housing body 11 and may enclose an internal space of the housing body 11. According to some embodiments, the housing cover 12 may be formed to have an approximately plate-like shape and may be disposed to face the open side of the housing body 11. The housing cover 12 may be fixed to the housing body 11 by various suitable types of coupling schemes such as bolting, welding, and fitting.

The battery cell 20 may function as a unit structure that is charged with power and discharges power in the battery pack 1. The battery cell 20 may be disposed inside the housing 10. A central axis C of the battery cell 20 may be disposed parallel to a height direction of the housing 10, that is, the Z-axis direction in FIG. 1. According to some embodiments, the plurality of battery cells 20 may be disposed inside the housing 10.

One or more battery cells 20 may be provided. Hereinafter, an example in which the plurality of battery cells 20 are provided will be described.

The plurality of battery cells 20 may be disposed to form various suitable patterns inside the housing 10. For example, the plurality of battery cells 20 may be disposed in two or more lines in a length direction and a width direction of the housing 10. The plurality of battery cells 20 may be coupled in parallel to each other. A layout of the plurality of battery cells 20 is not limited to that illustrated in FIGS. 1 to 3, and may be designed in various suitable forms.

According to some embodiments, the plurality of battery cells 20 may constitute first group battery cells 21 and second group battery cells 22. The first group battery cells 21 and the second group battery cells 22 may be electrically connected by the circuit board 50. According to some embodiments, the first group battery cells 21 and the second group battery cells 22 may be connected in series, in parallel, and/or in series-parallel (i.e., a combination of series and parallel connections) by the circuit board 50. According to some embodiments, the circuit board 50 may be disposed between the first group battery cells 21 and the second group battery cells 22.

The first group battery cells 21 and the second group battery cells 22 may each include three battery cells 20 connected in parallel, which may form one group and may be connected in series with battery cells 20 in another group. Accordingly, the first group battery cells 21 and the second group battery cells 22 may each include 21 battery cells 20 and may be provided in the form of 7s3p (i.e., seven battery cells in series and three battery cells in parallel). The layout of the first group battery cells 21 and the second group battery cells 22 in the form of 7s3p is merely an example, and the battery cells 20 may be connected in various suitable forms of series and parallel configurations.

According to some embodiments, the battery cells 20 may include first electrode end battery cells 20-1, second electrode end battery cells 20-2, and series-parallel battery cells 20-3.

The first electrode end battery cells 20-1 may be defined as the battery cells 20 connected by the first electrode parallel busbar 41.

The second electrode end battery cells 20-2 may be defined as battery cells 20 connected by a second electrode parallel busbar 42.

The series-parallel battery cells 20-3 may be defined as battery cell 20 other than the first electrode end battery cells 20-1 and the second electrode end battery cells 20-2 among the plurality of battery cells 20.

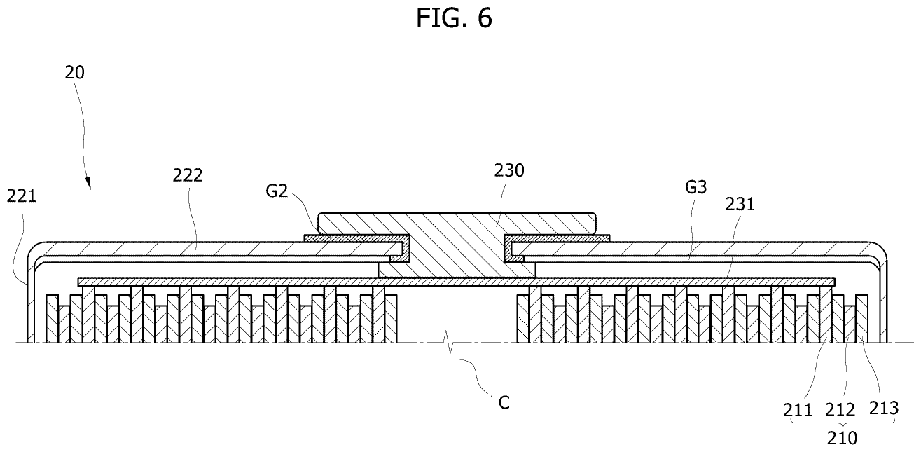

First electrode terminals (e.g., positive electrode terminals or terminals 230 in FIG. 6) of the first electrode end battery cells 20-1 may be connected in parallel by the first electrode parallel busbar 41.

Second electrode terminals (e.g., negative electrode terminals or a terminal plate 222 in FIG. 6) of the first electrode end battery cells 20-1 may be connected together (e.g., directly connected together to be at the same voltage) by a series-parallel busbar 43 and connected in series with first electrode terminals of the series-parallel battery cells 20-3.

Second electrode terminals of the second electrode end battery cells 20-2 may be connected together (e.g., directly connected together to be at the same voltage) by the second electrode parallel busbar 42.

First electrode terminals of the second electrode end battery cells 20-2 may be connected together (e.g., directly connected together to be at the same voltage)by the series-parallel busbar 43 and connected in series with the second electrode terminals of the series-parallel battery cells 20-3.

According to some embodiments, the first electrode end battery cells 20-1, the second electrode end battery cells 20-2, and the series-parallel battery cells 20-3 may be disposed parallel to one direction (e.g., a Y-axis direction). The series-parallel battery cells 20-3 may be disposed between the first electrode end battery cells 20-1 and the second electrode end battery cells 20-2.

The plurality of first electrode end battery cells 20-1 connected in parallel by the first electrode parallel busbar 41 may be disposed in a zigzag form. According to some embodiments, the plurality of first electrode end battery cells 20-1 may be disposed in a ‘V’ form.

The plurality of second electrode end battery cells 20-2 connected in parallel by the second electrode parallel busbar 42 may be disposed in a zigzag form. According to some embodiments, the plurality of second electrode end battery cells 20-2 may be disposed in a ‘V’ form.

The plurality of series-parallel battery cells 20-3 connected in series-parallel (i.e., a combination of series and parallel connections) by the series-parallel busbars 43 may be disposed in a zigzag form. According to some embodiments, the plurality of series-parallel battery cells 20-3 may be disposed in a ‘V’ form.

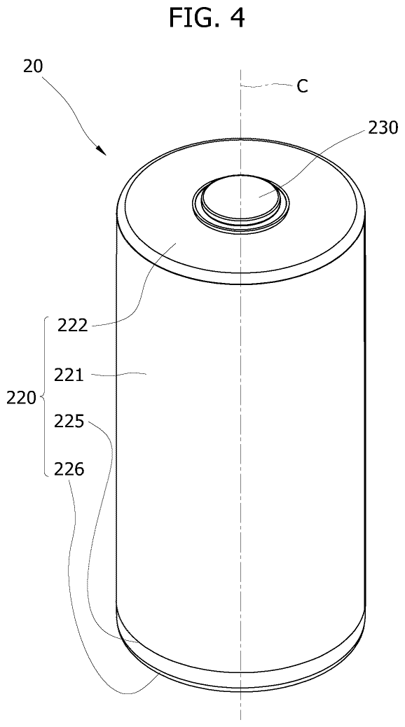

The battery cells 20 will be described later together with the description of FIGS. 4 to 6.

The holder part 30 may be accommodated in the housing 10. According to some embodiments, the holder part 30 may be accommodated in the housing body 11. The battery cells 20, the busbar assembly 40, and the circuit board 50 may be disposed in the holder part 30.

According to some embodiments, the plurality of battery cells 20 may be disposed inside the holder part 30, and the busbar assembly 40 and the circuit board 50 may be disposed on the upper side (e.g., in the +Z-axis direction) of the holder part 30.

The holder part 30 may include a lower holder 31 and an upper holder 32.

The lower holder 31 may be disposed below the upper holder 32 (e.g., in a −Z-axis direction). The battery cells 20 may be disposed in the lower holder 31.

The lower holder 31 may include a lower holder body 310 and lower holder recesses 311.

The lower holder body 310 may be provided in an approximately hexahedral shape. The shape of the lower holder body 310 is not limited to a hexahedron and may be provided in various suitable shapes.

The lower holder recesses 311 may be concave recesses extending from the upper side (e.g., in the +Z-axis direction) to the lower side (e.g., in the −Z-axis direction) of the lower holder body 310. The plurality of lower holder recesses 311 may be provided. According to some embodiments, the battery cells 20 may be inserted into each of the lower holder recesses 311.

The upper holder 32 may be disposed above the lower holder 31 (e.g., in a +Z-axis direction).

The upper holder 32 may include an upper holder body 320, an upper holder seating recess 321, and an upper holder terminal hole 322.

The upper holder body 320 may be provided in an approximately hexahedral shape. However, the shape of the upper holder body 320 is not limited to a hexahedron, and any suitable shape may be utilized.

The upper holder seating recess 321 may be provided on the upper side (e.g., in the +Z-axis direction) of the upper holder body 320. The upper holder seating recess 321 may be a recess formed to be concave from the upper side (e.g., the +Z-axis direction) to the lower side (e.g., the −Z-axis direction) of the upper holder body 320. The busbar assembly 40 may be disposed in the upper holder seating recess 321.

There are various suitable shapes of the upper holder seating recess 321. The shape of the upper holder seating recess 321 may correspond to the shape of the busbar assembly 40. According to some embodiments, the shape of the upper holder seating recess 321 may correspond to the shape of the first electrode parallel busbar 41, the second electrode parallel busbar 42, and/or the series-parallel busbar 43.

The upper holder terminal hole 322 may be a hole passing through the upper holder body 320. The battery cell 20 may be disposed in the upper holder terminal hole 322. According to some embodiments, the battery cell 20 inserted into the upper holder terminal hole 322 may be exposed from the upper side (e.g., the +Z-axis direction) of the upper holder body 320. The battery cell 20 exposed from the upper side of the upper holder body 320 may be electrically connected to the busbar assembly 40 disposed on the upper side (e.g., the +Z-axis direction) of the upper holder body 320.

Thus, the lower holder 31 may be disposed in lower portions (e.g., in the −Z-axis direction) of the battery cells 20, and the upper holder 32 may be disposed in upper portions (e.g., in the +Z-axis direction) of the battery cells 20, such that the plurality of battery cells 20 can be fixed to the holder part 30.

The busbar assembly 40 may be disposed on the upper side (e.g., in the +Z-axis direction) of the holder part 30. According to some embodiments, the busbar assembly 40 may be disposed in the upper holder seating recess 321 of the upper holder 32.

The busbar assembly 40 may electrically connect the battery cells 20. The busbar assembly 40 may connect the battery cells 20 in series, in parallel, or in series-parallel (i.e., a combination of series and parallel connections).

The busbar assembly 40 may include the first electrode parallel busbar 41, the second electrode parallel busbar 42, and the series-parallel busbar 43.

The first electrode parallel busbar 41 may connect first electrodes (e.g., positive electrodes) of the plurality of battery cells 20 together (e.g., connect directly together to be at the same voltage). According to some embodiments, the first electrode parallel busbar 41 may connect the first electrodes of two or more of the battery cells 20 together (e.g., connect directly together to be at the same voltage). For example, the first electrode parallel busbar 41 may connect the first electrodes of the three battery cells 20 together (e.g., to be at the same voltage).

The first electrode parallel busbar 41 may be connected to the circuit board 50. When the first electrode parallel busbar 41 is connected to the circuit board 50, information on current, voltage, temperature, or the like of the first electrode parallel busbar 41 may be transferred to the circuit board 50.

The second electrode parallel busbar 42 may connect second electrodes (e.g., negative electrodes) of the plurality of battery cells 20 together (e.g., to be at the same voltage). According to some embodiments, the second electrode parallel busbar 42 may connect the second electrodes of two or more of the battery cells 20 together (e.g., to be at the same voltage). For example, the second electrode parallel busbar 42 may connect the second electrodes of the three battery cells 20 together (e.g., to be at the same voltage).

The second electrode parallel busbar 42 may be connected to the circuit board 50. Because the second electrode parallel busbar 42 is connected to the circuit board 50, information on a current, voltage, temperature, or the like of the second electrode parallel busbar 42 may be transferred to the circuit board 50.

The series-parallel busbar 43 may connect a first electrode of a first battery cell and a second electrode of a second battery cell among the plurality of battery cells 20 in series. According to some embodiments, the series-parallel busbar 43 may connect the first electrodes (e.g., positive electrodes) of the plurality of battery cells 20 connected together by the first electrode parallel busbar 41 and the second electrodes (e.g., negative electrodes) of the plurality of battery cells 20 connected together by the second electrode parallel busbar 42 to connect the battery cells 20 in series and in parallel.

The series-parallel busbar 43 may be connected to the circuit board 50. Because the series-parallel busbar 43 is connected to the circuit board 50, information on a current, voltage, temperature, or the like of the series-parallel busbar 43 may be transferred to the circuit board 50.

The busbar assembly 40 may include a first busbar assembly 40-1 and a second busbar assembly 40-2. Each of the first busbar assembly 40-1 and the second busbar assembly 40-2 may include the first electrode parallel busbar 41, the second electrode parallel busbar 42, and the series-parallel busbar 43.

The first group battery cells 21 may be connected in series, in parallel, and/or in series-parallel (i.e., a combination of series and parallel connections) by the first busbar assembly 40-1 and may be connected to the circuit board 50.

The second group battery cells 22 may be connected in series, in parallel, and/or in series-parallel (i.e., a combination of series and parallel connections) by the second busbar assembly 40-2 and may be connected to the circuit board 50.

The circuit board 50 may be connected to the battery cells 20 through the busbar assembly 40. According to some embodiments, the circuit board 50 may be connected to the battery cells 20 through the first electrode parallel busbar 41, the second electrode parallel busbar 42, and/or the series-parallel busbar 43. The circuit board 50 may be connected to the first electrode parallel busbar 41, the second electrode parallel busbar 42, and/or the series-parallel busbar 43 to measure a voltage, current, and temperature of the battery cells 20 connected to the first electrode parallel busbar 41, the second electrode parallel busbar 42, and/or the series-parallel busbar 43.

The circuit board 50 may include a circuit board body 500 and a circuit board connection portion 501.

The circuit board body 500 may be provided in an approximately hexahedral shape. However, the shape of the circuit board body 500 is not limited to a hexahedron, and any suitable shape may be utilized.

A circuit board connection portion 501 connected to the busbar assembly 40 may be disposed in the circuit board body 500. According to some embodiments, the circuit board body 500 may be connected to the first electrode parallel busbar 41, the second electrode parallel busbar 42 and/or the series-parallel busbar 43 through the circuit board connection portion 501 to receive information such as the voltage, current, and temperature of the battery cells 20.

The circuit board body 500 may connect the first group battery cells 21 and the second group battery cells 22. According to some embodiments, the circuit board body 500 may connect the first group battery cells 21 and the second group battery cells 22 in series, in parallel, and/or in series-parallel (i.e., a combination of series and parallel connections). Accordingly, a voltage, current capacity, or the like of the battery pack 1 can be adjusted. The circuit board body 500 may be disposed between the first group battery cells 21 and the second group battery cells 22.

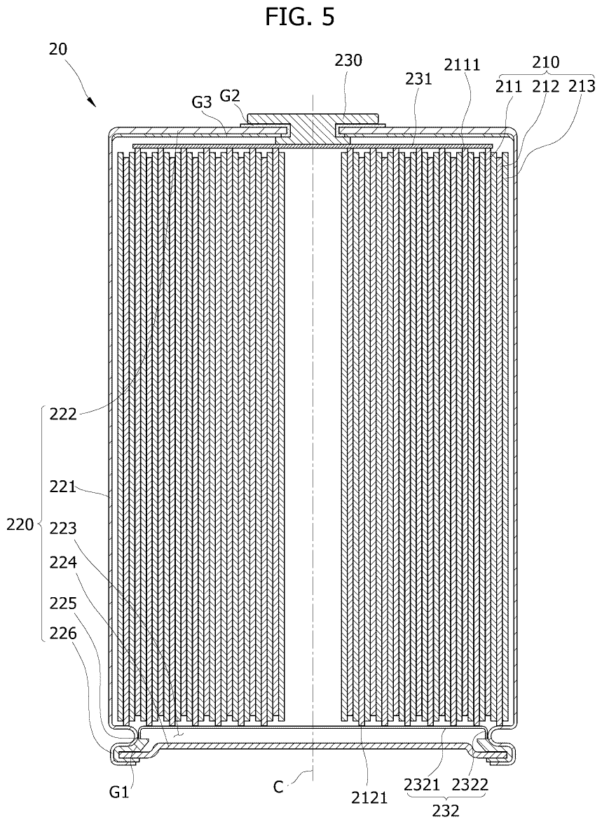

FIG. 4 is a perspective view of a battery cell according to some embodiments of the present disclosure. FIG. 5 is a cross-sectional view schematically illustrating a configuration of the battery cell according to some embodiments of the present disclosure. FIG. 6 is a cross-sectional view schematically illustrating a configuration of the battery cell according to some embodiments of the present disclosure.

Referring to FIGS. 4 to 6, the battery cell 20 according to some embodiments includes an electrode assembly 210, a case 220, and the terminal 230.

Hereinafter, an example in which the battery cell 20 is a cylindrical lithium ion secondary battery will be described. However, the present disclosure is not limited thereto, and the battery cell 20 may be a lithium polymer battery a prismatic battery, or any other suitable battery type.

The electrode assembly 210 may function as a unit structure that performs power charging and discharging operations in the battery cell.

The electrode assembly 210 may include a first electrode 211, a second electrode 212, and a separator 213 disposed between the first electrode 211 and the second electrode 212.

The electrode assembly 210 may have a shape wound around a winding axis.

For example, the electrode assembly 210 may have a shape wound clockwise or counterclockwise around the winding axis in a state where the first electrode 211, the separator 213, and the second electrode 212 are stacked. Accordingly, the electrode assembly 210 may have an approximately jellyroll-like shape. A cross-sectional shape of the electrode assembly 210 may be designed to be various suitable shapes such as an oval or polygon in addition to a circle. The winding axis of the electrode assembly 210 may be disposed on the same straight line as the central axis C of the battery cell 20.

The first electrode 211 may function as a positive electrode of the electrode assembly 210. The first electrode 211 may be formed to have the form of a foil containing a metal material such as aluminum or an aluminum alloy. A type, size, shape, or the like of the first electrode 211 is not particularly limited as long as the first electrode 211 does not cause a chemical change in the battery cell 20 and is conductive.

A first active material layer may be applied to at least a portion of the first electrode 211. The first active material layer may be applied to both surfaces of the first electrode 211, or may be applied to only one surface of the first electrode 211.

When the first electrode 211 functions as a positive electrode, the first active material layer may include a positive electrode active material.

The positive electrode active material may be a compound capable of reversible lithium intercalation and deintercalation (i.e., may be a lithiated intercalation compound). For example, the positive electrode active material may be at least one of composite oxides of lithium and a metal selected from cobalt, manganese, nickel, iron, and combinations thereof.

For example, the positive electrode active material may include at least one of a lithium—iron—phosphorus oxide (LiFePO4, LFP), a lithium—manganese—iron—phosphorus oxide (LiMnFePO4, LMFP), and a lithium—nickel—cobalt—manganese oxide (LiNixCoyMnzO2, LNCM). Here, 0<x<1, 0<y<1, 0<z<1, such that x+y+z=1 may be satisfied. The positive electrode active material may include only one of the lithium—iron—phosphorus oxide (LiFePO4, LFP), the lithium—manganese—iron—phosphorus oxide (LiMnFePO4, LMFP), and the lithium—nickel—cobalt—manganese oxide (LiNixCoyMnzO2, LNCM), or may include two or all of the lithium—iron—phosphorus oxide (LiFePO4, LFP), the lithium—manganese—iron—phosphorus oxide (LiMnFePO4, LMFP), and the lithium—nickel—cobalt—manganese oxide (LiNixCoyMnzO2, LNCM).

The first active material layer may further include a positive electrode conductive material.

The positive electrode conductive material is used to impart conductivity to the first active material layer, and may be any suitable material that does not cause a chemical change and is electronically conductive. Examples of the positive electrode conductive material may include carbon-based materials such as natural graphite, artificial graphite, carbon black, acetylene black, Ketjen black, carbon fibers, carbon nanofibers, and carbon nanotubes, metal-based materials in the form of a metal powder or metal fiber containing copper, nickel, aluminum, silver, or the like, conductive polymers such as polyphenylene derivatives, or mixtures thereof.

The first active material layer may further include a positive electrode binder.

The positive electrode binder serves to firmly bind particles constituting a positive electrode active material to each other and also to firmly bind the positive electrode active material to the first electrode 211.

Examples of the positive electrode binder include a non-aqueous binder, an aqueous binder, a dry binder, or a combination thereof.

Examples of the non-aqueous binder may include polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamideimide, polyimide, and a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, fluoroelastomer, polyethylene oxide, polyvinylpyrrolidone, polyepichlorohydrin, polyphosphazene, poly(meth)acrylonitrile, ethylene propylene diene copolymer, polyvinylpyridine, chlorosulfonated polyethylene, latex, a polyester resin, a (meth)acrylic resin, a phenol resin, an epoxy resin, polyvinyl alcohol, and combinations thereof.

When the aqueous binder is used as the positive electrode binder, a cellulose-based compound capable of imparting viscosity may be further included. The cellulose-based compound may be a mixture of one or more kinds of carboxymethyl cellulose, hydroxypropyl methyl cellulose, methyl cellulose, an alkali metal salt thereof, and the like. The alkali metal may be Na, K, or Li.

The dry binder may be a polymer material capable of being fiberized and may be, for example, polytetrafluoroethylene, polyvinylidene fluoride, polyvinylidene fluoride-hexafluoropropylene copolymer, polyethylene oxide, or a combination thereof.

The first electrode 211 may include a first uncoated portion 2111 that is not coated with the first active material layer. The first uncoated portion 2111 may protrude a set or predetermined distance from one end of the electrode assembly 210 along the winding axis.

The second electrode 212 may function as a negative electrode of the electrode assembly 210. The second electrode 212 may be formed to have the shape of a foil including a metal material such as copper, a copper alloy, nickel, or a nickel alloy. The second electrode 212 may be spaced a set or predetermined distance from the first electrode 211 and disposed to face the first electrode 211.

A type, size, shape, or the like of the second electrode 212 is not particularly limited as long as the second electrode 212 does not cause a chemical change in the battery cell and is conductive.

At least a portion of the second electrode 212 may be coated with a second active material layer. Both surfaces of the second electrode 212 may be coated with the second active material layer or only one of the surfaces of the second electrode 212 may be coated with the second active material layer.

Because the second electrode 212 functions as a negative electrode, the second active material layer may include a negative electrode active material.

The negative electrode active material may include a material capable of reversible lithium-ion intercalation/deintercalation, a lithium metal, an alloy of lithium metal, a material capable of lithium doping and de-doping, or a transition metal oxide.

The material capable of reversible lithium-ion intercalation/deintercalation may include a carbon-based negative electrode active material, such as crystalline carbon, amorphous carbon, or a combination thereof. Examples of the crystalline carbon may include graphite, such as natural graphite or artificial graphite in an amorphous, plate-like, flake-like, spherical, or fiber-like form, and examples of the amorphous carbon may include soft carbon or hard carbon, mesophase pitch carbides, and calcined coke.

The alloy of lithium metal may be an alloy of the lithium and a metal selected from Na, K, Rb, Cs, Fr, Be, Mg, Ca, Sr, Si, Sb, Pb, In, Zn, Ba, Ra, Ge, Al, and Sn.

The material capable of lithium doping and de-doping may be a Si-based negative electrode active material or a Sn-based negative electrode active material. The Si-based negative electrode active material may be silicon, a silicon-carbon composite, SiOx (0<x<2), a Si-Q alloy (Q is selected from an alkali metal, an alkaline earth metal, a Group 13 element, a Group 14 element (excluding Si), a Group 15 element, a Group 16 element, a transition metal, a rare earth element, and a combination thereof), or a combination thereof. The Sn-based negative electrode active material may be Sn, SnO2, a Sn-based alloy, or a combination thereof.

The silicon-carbon composite may be a composite of silicon and amorphous carbon. According to some embodiments, the silicon-carbon composite may be in the form of silicon particles and amorphous carbon coated on surfaces of the silicon particles. For example, the silicon-carbon composite may include secondary particles (e.g., cores) obtained by assembling primary silicon particles, and amorphous carbon coating layers (e.g., shells) located on surfaces of the secondary particles. The amorphous carbon may also be located between the silicon primary particles, for example, so that the primary silicon particles may be coated with the amorphous carbon. The secondary particles may be dispersed and present in an amorphous carbon matrix.

The silicon-carbon composite may further include crystalline carbon. For example, the silicon-carbon composite may include a core including crystalline carbon and silicon particles, and an amorphous carbon coating layer located on a surface of the core.

The Si-based negative electrode active material or the Sn-based negative electrode active material may be used in combination with the carbon-based negative electrode active material.

The second active material layer may further include a negative electrode conductive material and a negative electrode binder.

The negative electrode conductive material is used to impart conductivity to the second active material layer, and can be any material that does not cause a chemical change and is electronically conductive. Examples of the negative electrode conductive material may include carbon-based materials such as natural graphite, artificial graphite, carbon black, acetylene black, Ketjen black, carbon fibers, carbon nanofibers, and carbon nanotubes, metal-based materials in the form of a metal powder or metal fiber containing copper, nickel, aluminum, silver, or the like, conductive polymers such as polyphenylene derivatives, or mixtures thereof.

The negative electrode binder serves to firmly bind the particles constituting the negative electrode active material to each other and also to firmly bind the negative electrode active material to the second electrode 212.

Examples of the negative electrode binder include a non-aqueous binder, an aqueous binder, a dry binder, and a combination thereof.

The non-aqueous binder may include polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, fluoroelastomer, polyethylene oxide, polyvinylpyrrolidone, polyepichlorohydrin, polyphosphazene, poly(meth)acrylonitrile, ethylene propylene diene copolymer, polyvinylpyridine, chlorosulfonated polyethylene, latex, a polyester resin, a (meth)acrylic resin, a phenol resin, an epoxy resin, polyvinyl alcohol, and combinations thereof.

When the aqueous binder is used as the negative electrode binder, a cellulose-based compound capable of imparting viscosity may be further included. The cellulose-based compound may be a mixture of one or more kinds of carboxymethyl cellulose, hydroxypropyl methyl cellulose, methyl cellulose, an alkali metal salt thereof, and the like. The alkali metal may be Na, K, Li, or the like.

The dry binder may be a polymer material capable of fiberization and may be, for example, polytetrafluoroethylene, polyvinylidene fluoride, polyvinylidene fluoride-hexafluoropropylene copolymer, polyethylene oxide, or a combination thereof.

The second electrode 212 may include a second uncoated portion 2121 that is not coated with a second active material layer. The second uncoated portion 2121 may protrude a set or predetermined distance from the other end of the electrode assembly 210 located on the opposite side of the first uncoated portion 2111 along the winding axis.

The separator 213 may be disposed between the first electrode 211 and the second electrode 212. The separator 213 may function to prevent a short circuit between the first electrode 211 and the second electrode 212 while allowing lithium ions to move between the first electrode 211 and the second electrode 212.

The separator 213 may be made of polyethylene, polypropylene, polyvinylidene fluoride, or a multilayer film including two or more layers of these materials, and may be a mixed multilayer film such as a two-layer separator including polyethylene and polypropylene, a three-layer separator including polyethylene, polypropylene, and polyethylene, or a three-layer separator including polypropylene, polyethylene, and polypropylene.

The separator 213 may include a porous substrate, and a coating layer including an organic material, an inorganic material, or a combination thereof located on one or both sides of the porous substrate.

The porous substrate may be a polymer film formed of any one polymer selected from polyolefins such as polyethylene and polypropylene, polyesters such as polyethylene terephthalate and polybutylene terephthalate, polyacetal, polyamide, polyimide, polycarbonate, polyether ketone, polyarylether ketone, polyetherimide, polyamideimide, polybenzimidazole, polyether sulfone, polyphenylene oxide, cyclic olefin copolymer, polyphenylene sulfide, polyethylene naphthalate, glass fiber, Teflon, and polytetrafluoroethylene, or a copolymer or mixture of two or more of the materials.

The organic material may include a polyvinylidene fluoride-based polymer or a (meth)acrylic polymer.

The inorganic material may include inorganic particles selected from Al2O3, SiO2, TiO2, SnO2, CeO2, MgO, NiO, CaO, GaO, ZnO, ZrO2, Y2O3, SrTiO3, BaTiO3, Mg(OH)2, boehmite, and combinations thereof, but is not limited thereto.

The organic material and the inorganic material may be mixed and present in one coating layer, or may be present in a form in which a coating layer including the organic material and a coating layer including the inorganic material are stacked.

A pair of separators 213 may be provided. The separators 213 in the pair may be disposed to face both surfaces of the first electrode 211 or the second electrode 212. The pair of separators 213 may be wound around the winding axis together with the first electrode 211 and the second electrode 212.

The case 220 may form a schematic exterior of the battery cell 20 and may accommodate the electrode assembly 210. The case 220 may be electrically conductive. For example, the case 220 may include at least one of steel, stainless steel, aluminum, and an aluminum alloy.

The case 220 may include a can 221 and a cap plate 224.

The can 221 may be formed to have a cylindrical shape having an approximately circular cross-section. A diameter of the can 221 may be larger than that of the electrode assembly 210. A length of the can 221 parallel to the winding axis of the electrode assembly 210 may be larger than that of the electrode assembly 210.

The electrode assembly 210 may be accommodated inside the can 221. A central axis of the can 221 may be disposed on the same straight line as the central axis C of the battery cell 20. The central axis of the can 221 may be disposed to be coaxial with the winding axis of the electrode assembly 210.

The can 221 may include the terminal plate 222 and an opening portion 223.

The terminal plate 222 and the opening portion 223 may be disposed at both ends of the can 221. The terminal plate 222 and the opening portion 223 may be disposed apart from each other along the winding axis of the electrode assembly 210. The terminal plate 222 may include iron (Fe).

The terminal plate 222 according to some embodiments may be formed to have a disk-like shape disposed at one of the ends of the can 221. The terminal plate 222 may be disposed inside the housing body 11 to face the housing cover 12. An outer circumferential surface of the terminal plate 222 may be formed integrally with an inner circumferential surface of the can 221 to seal the one end of the can 221. For example, the can 221 and the terminal plate 222 may be shaped through a deep drawing process. In some examples, the terminal plate 222 may be manufactured separately from the can 221 and the outer circumferential surface thereof may be coupled to the inner circumferential surface of the can 221. A through hole into which the terminal 230 to be described below is inserted may be formed in a central portion of the terminal plate 222.

The opening portion 223 according to some embodiments may be formed to have the shape of a hole that passes through the other end of the can 221. The opening portion 223 may be disposed to face a bottom surface of the housing body 11 inside the housing body 11. Both sides of the opening portion 223 may be connected to an internal space of the can 221 and an external space of the can 221. In a process of manufacturing the battery cell 20, the electrode assembly 210 may be inserted into the can 221 through the opening portion 223 together with electrolyte.

The first uncoated portion 2111 of the electrode assembly 210 may be disposed inside the can 221 to face the terminal plate 222. The second uncoated portion 2121 of the electrode assembly 210 may be disposed inside the can 221 to face the opening portion 223.

A case gasket G3 may be disposed between the electrode assembly 210 and the terminal plate 222 to electrically insulate the electrode assembly 210 from the terminal plate 222. The case gasket G3 may function as a component that electrically insulates the electrode assembly 210 from the terminal plate 222 by blocking direct contact between the case 220 and the first electrode 211.

The case gasket G3 according to some embodiments may be disposed between one surface of the electrode assembly 210 in which the first uncoated portion 2111 protrudes and an inner surface of the terminal plate 222 disposed to face the internal space of the can 221. The case gasket G3 may be fixed to the inner surface of the terminal plate 222 using an adhesive or the like. The case gasket G3 may be formed of an insulating material such as rubber, polyethylene (PE), polypropylene (PP), or polyethylene terephthalate (PET).

The cap plate 224 may be configured to seal the opening portion 223 of the can 221.

The cap plate 224 according to some embodiments may be formed to have a generally disk-like shape. The cap plate 224 may be disposed at the opening portion 223 of the can 221. An inner surface of the cap plate 224 may be disposed to face the other surface of the electrode assembly 210 in which the second uncoated portion 2121 protrudes in the opening portion 223. An outer surface of the cap plate 224 may be disposed to face the external space of the can 221. An outer surface of the cap plate 224 may be disposed to face the bottom surface of the housing body 11 inside the housing body 11. The cap plate 224 may be formed of a metal material to provide mechanical rigidity, or may be formed of a synthetic resin material having no electrical conductivity.

A groove may be formed in the cap plate 224, and when an event (e.g., a fire) occurs in the battery cell 20, the cap plate 224 may be broken due to the groove formed in the cap plate 224. Therefore, when the groove is formed in the cap plate 224, the cap plate 224 may function as a vent.

The case 220 according to some embodiments may further include a beading portion 225 and a crimping portion 226.

The beading portion 225 may be a portion of an entire area of the can 221 that protrudes from the inner circumferential surface of the can 221 toward the central axis of the can 221. The beading portion 225 may be formed by pressing an outer circumferential surface of the can 221 from a side adjacent to the opening portion 223. The beading portion 225 may be in contact with the other end of the electrode assembly 210 in which the second uncoated portion 2121 protrudes. Accordingly, the beading portion 225 can prevent the electrode assembly 210 from moving or being separated inside the can 221. An edge area of the inner surface of the cap plate 224 may be disposed to face the other end of the electrode assembly 210 in which the second uncoated portion 2121 protrudes, with the beading portion 225 interposed therebetween.

The crimping portion 226 may be disposed at one end of the can 221 where the opening portion 223 is formed. The crimping portion 226 may function as a component for fixing the cap plate 224 at the opening portion 223.

The crimping portion 226 according to some embodiments may be bent from one end of the can 221 surrounding the opening portion 223. The crimping portion 226 may be disposed to face the outer surface of the cap plate 224 that is disposed to face the external space of the can 221.

A cap gasket G1 may be disposed between the cap plate 224 and the crimping portion 226 to electrically insulate the cap plate 224 from the case 220.

The cap gasket G1 according to some embodiments may be disposed to fully surround an end of the cap plate 224. An outer surface of the cap gasket G1 may be press-fixed to inner surfaces of the beading portion 225 and the crimping portion 226. The cap gasket G1 may be formed of an insulating material such as rubber, polyethylene (PE), polypropylene (PP), or polyethylene terephthalate (PET). Accordingly, the cap gasket G1 can electrically insulate the cap plate 224 from the case 220, and prevent moisture, foreign substances, or the like from flowing between the cap plate 224 and the case 220, or substantially reduce the likelihood thereof.

The crimping portion 226 may be disposed to face the other surface of the cap plate 224 with the cap gasket G1 interposed therebetween, and press the cap plate 224 toward the beading portion 225 by coming into contact with the cap gasket G1. Accordingly, the cap plate 224 can be stably fixed on the opening portion 223 side of the case 220.

The terminal 230 may be coupled to the terminal plate 222 and may protrude outward from the terminal plate 222. The terminal 230 may be made of a metal material having electrical conductivity, such as aluminum, nickel, or copper.

The terminal 230 according to some embodiments may pass through the terminal plate 222 along the central axis C of the battery cell 20. A central axis of the terminal 230 may be disposed coaxially with the central axis C of the battery cell 20.

For example, a central portion of the terminal 230 may be inserted into the through hole formed in the terminal plate 222. An outer peripheral surface of the terminal 230 may be disposed a set or predetermined distance from an inner peripheral surface of the through hole formed in the central portion of the terminal plate 222.

Both upper and lower ends of the terminal 230 may be disposed in the inner space and the external space of the can 221. Both ends of the terminal 230 disposed in the inner space and the external space of the can 221 may be compressed and deformed by riveting and may be disposed to face an outer surface and the inner surface of the terminal plate 222. Accordingly, an edge area of the terminal 230 may have an approximately U-shaped cross-section.

A terminal gasket G2 may be disposed between the terminal 230 and the case 220 to electrically insulate the terminal 230 from the case 220.

The terminal gasket G2 according to some embodiments may be disposed to fully surround the inner circumferential surface of the through hole formed in the terminal plate 222 and the outer surface and the inner surface of the terminal plate 222 facing both ends of the terminal 230. Both surfaces of the terminal gasket G2 may be in close contact with surfaces of the terminal plate 222 and the terminal 230. The terminal gasket G2 may be formed of an insulating material such as rubber, polyethylene (PE), polypropylene (PP), or polyethylene terephthalate (PET).

The terminal 230 may be electrically connected to the first electrode 211 of the electrode assembly 210. Because the terminal 230 is electrically connected to the first electrode 211, the terminal 230 may function as a first electrode terminal. Because the first electrode 211 of the electrode assembly 210 is illustrated as the positive electrode in some embodiments, the terminal 230 may function as a positive electrode terminal of the battery cell 20.

For example, the terminal 230 may be connected to the first electrode 211 of the electrode assembly 210 by a first current collection member 231.

The first current collection member 231 may be disposed between the electrode assembly 210 and the terminal 230. The first current collection member 231 may function as a component that electrically connects the electrode assembly 210 and the terminal 230.

The first current collection member 231 according to some embodiments may be disposed between the one surface of the electrode assembly 210 in which the first uncoated portion 2111 protrudes and the other end of the terminal 230 positioned in an internal space of the case 220. The first current collection member 231 may be made of a metal material having electrical conductivity, such as aluminum, nickel, or copper.

The first current collection member 231 may have an approximately disk-like shape. Both surfaces of the first current collection member 231 may be in contact with the first uncoated portion 2111 and the terminal 230. An end of the first uncoated portion 2111 may be bent in a direction parallel to the first current collection member 231 and connected to a lower surface of the first current collection member 231 by laser welding, ultrasonic welding, or the like. An upper surface of the first current collection member 231 may be in contact with a lower surface of the terminal 230 protruding into the inside of the can 221 and connected to the lower surface of the first current collection member 231 by laser welding, ultrasonic welding, or the like. Accordingly, the first current collection member 231 may provide an electrical connection between the electrode assembly 210 and the terminal 230.

The can 221 may be electrically connected to the second electrode 212 of the electrode assembly 210. According to some embodiments, the terminal plate 222 connected to the can 221 may function as a second electrode terminal. In some embodiments, the first electrode 211 of the electrode assembly 210 is illustrated as the positive electrode, and the terminal plate 222 included in the can 221 may function as a negative electrode terminal of the battery cell 20.

For example, the can 221 may be connected to the second electrode 212 of the electrode assembly 210 by the second current collection member 232.

The second current collection member 232 may be disposed between the electrode assembly 210 and the cap plate 224. The second current collection member 232 may function as a component that electrically connects the electrode assembly 210 and the case 220. The second current collection member 232 may be made of a metal material having electrical conductivity, for example, aluminum, nickel, or copper.

The second current collection member 232 according to some embodiments may include a flat portion 2321 facing the other side of the electrode assembly 210 in which the second uncoated portion 2121 protrudes, and an extension portion 2322 extending from the flat portion 2321.

An upper surface of the flat portion 2321 facing the other side of the electrode assembly 210 may be connected to the second uncoated portion 2121. An end of the second uncoated portion 2121 may be bent in a direction parallel to the flat portion 2321 and connected to one surface of the flat portion 2321 by welding or the like. A direction in which the second uncoated portion 2121 is bent may be a direction toward the winding axis of the electrode assembly 210.

The extension portion 2322 may extend from an edge of the flat portion 2321 toward the cap plate 224. The extension portion 2322 may be in contact with the inner side of the beading portion 225. The extension portion 2322 may be rounded or bent along the beading portion 225. The extension portion 2322 may be connected to the beading portion 225 by welding or the like. Accordingly, the case 220 and the second electrode 212 are electrically connected, and the terminal plate 222 may function as the negative electrode.

A plurality of extension portions 2322 may be formed. The plurality of extension portions 2322 may be disposed apart from each other along the edge of the flat portion 2321.

The terminal 230 may pass through the terminal plate 222 along the central axis C of the battery cell 20. The terminal gasket G2 may be disposed between the terminal 230 and the terminal plate 222.

A central axis of the terminal plate 222 may be positioned coaxially with the central axis C of the battery cell 20.

The busbar assembly 40 may be disposed to face the terminal plate 222 and/or the terminal 230 inside the housing 10.

The busbar assembly 40 may be electrically connected to the terminal plate 222 and/or the terminal 230. The busbar assembly 40 may function as a component that electrically connects the terminal plates 222 and/or the terminals 230 of the plurality of battery cells 20, or provides an electrical connection between the terminal plates 222 and/or the terminals 230 and a control circuit of the battery pack 1 or an external power device.

A plurality of the busbar assemblies 40 may be provided. Each busbar assembly 40 may be individually connected to the terminal plate 222 and/or terminal 230 of a different battery cell 20.

The busbar assembly 40 according to some embodiments may have the shape of a plate including at least one conductive metal among aluminum, nickel, and copper. The busbar assembly 40 may be formed in a straight shape, and may also have a bending structure having one or more bending sections.

The busbar assembly 40 may be in contact with an upper surface of the terminal plate 222 and coupled to the upper surface of the terminal plate 222 by welding or the like.

The busbar assembly 40 may be in contact with an upper surface of the terminal 230 and coupled to the upper surface of the terminal 230 by welding or the like.

The busbar assembly 40 may connect the plurality of battery cells 20 in parallel, in series, or in series-parallel (i.e., a combination of series and parallel connections).

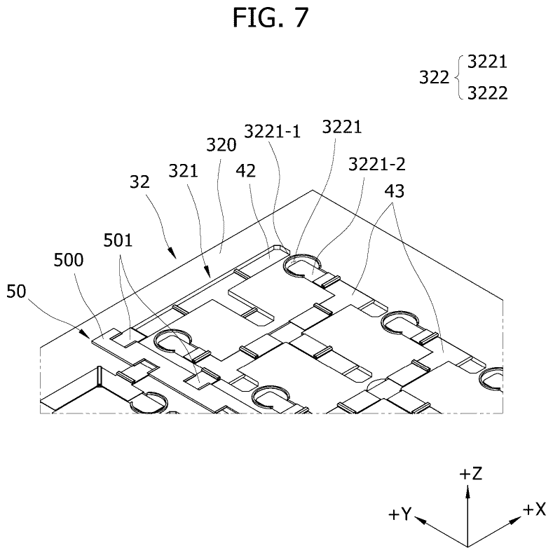

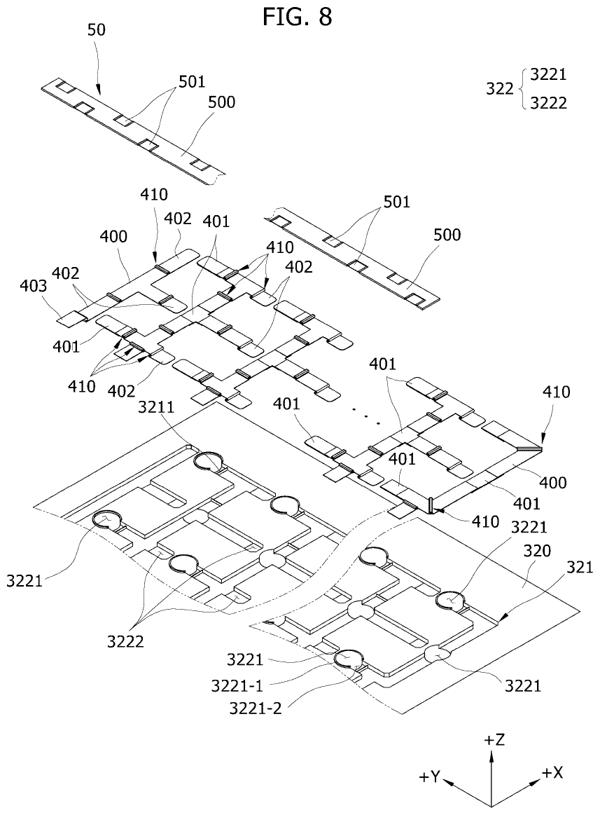

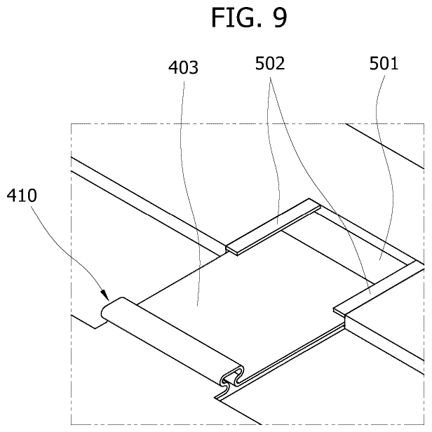

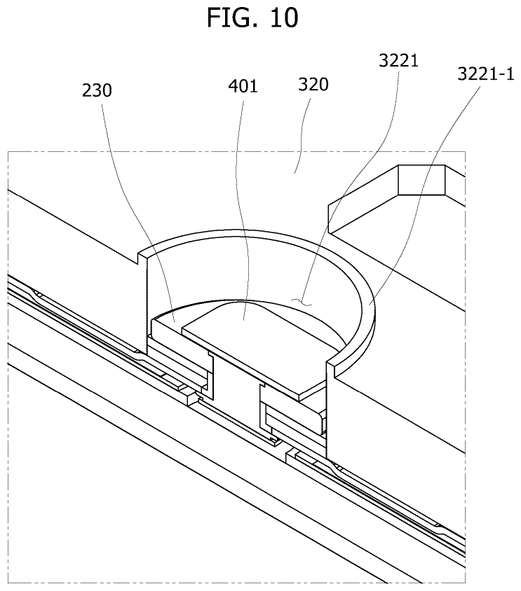

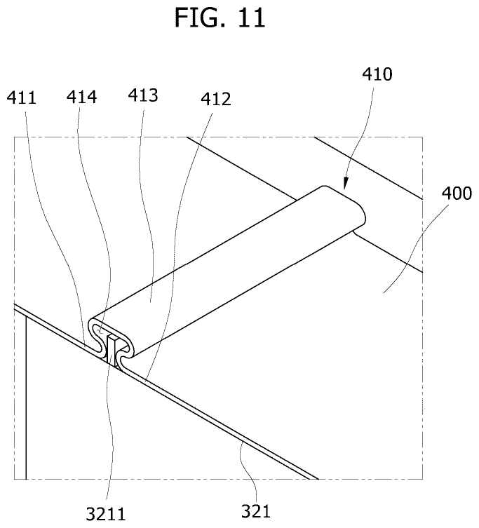

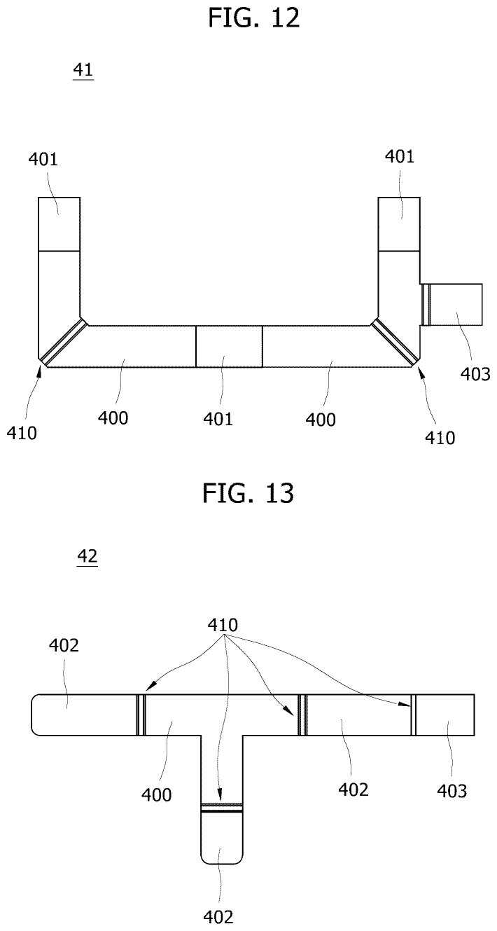

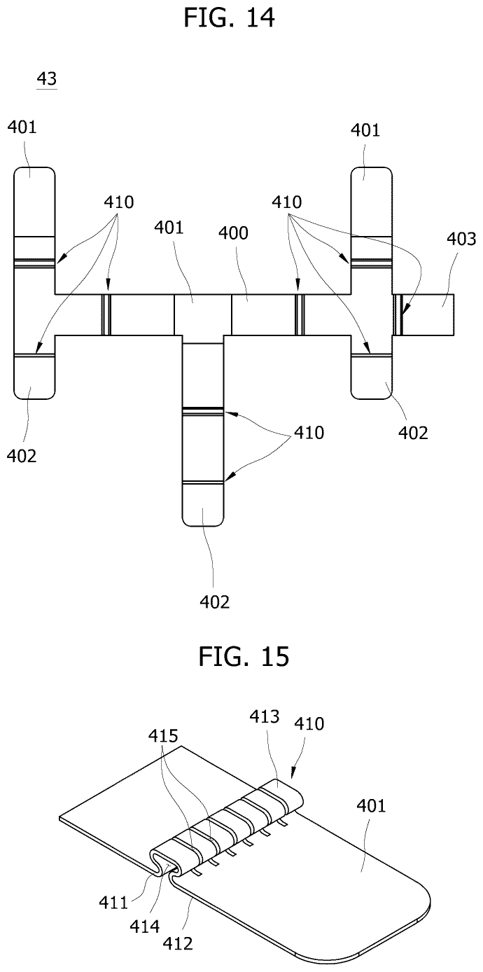

FIG. 7 is a perspective view of the holder part, the busbar assembly, and the circuit board according to some embodiments of the present disclosure. FIG. 8 is an exploded perspective view of the holder part, the busbar assembly, and the circuit board according to some embodiments of the present disclosure. FIG. 9 is a perspective view of the circuit board and the busbar assembly according to some embodiments of the present disclosure. FIG. 10 is a cross-sectional perspective view of a portion of the holder part and the battery cell according to some embodiments of the present disclosure. FIG. 11 is a cross-sectional perspective view of a portion of the holder part and the busbar assembly according to some embodiments of the present disclosure. FIG. 12 is a plan view of the first electrode parallel busbar according to some embodiments of the present disclosure. FIG. 13 is a plan view of the second electrode parallel busbar according to some embodiments of the present disclosure. FIG. 14 is a plan view of the series-parallel busbar according to some embodiments of the present disclosure.

The holder part 30, the busbar assembly 40, and the circuit board 50 will be described with reference to FIGS. 7 to 14.

The holder part 30 may include the lower holder 31 and the upper holder 32.

The upper holder 32 may include an upper holder body 320, an upper holder seating recess 321, and an upper holder terminal hole 322.

The upper holder body 320 may have an approximately hexahedral shape. The upper holder body 320 may be made of an insulating material that does not conduct electricity. According to some embodiments, the upper holder body 320 may be made of a synthetic resin such as a plastic.

The upper holder seating recess 321 may be a recess formed to be concave in the upper holder body 320. The busbar assembly 40 may be disposed in the upper holder seating recess 321. According to some embodiments, the first electrode parallel busbar 41, the second electrode parallel busbar 42, and/or the series-parallel busbar 43 may be inserted into the upper holder seating recess 321.

There are various suitable shapes of the upper holder seating recess 321. The shape of the upper holder seating recess 321 may be provided to correspond to the shape of the first electrode parallel busbar 41, the second electrode parallel busbar 42, and/or the series-parallel busbar 43.

An upper holder seating projection 3211 formed to protrude from the upper holder body 320 may be disposed in the upper holder seating recess 321. The upper holder seating projection 3211 may be inserted into a bending recess portion 414 formed in the busbar body 400.

Because the upper holder seating projection 3211 is inserted into the bending recess portion 414, the busbar body 400 may be fixed to the upper holder 32.

The upper holder 32 may include the upper holder terminal hole 322 provided as a hole passing through the upper holder body 320. Through the upper holder terminal hole 322, the terminal plate 222 and/or the terminal 230 of the battery cell 20 may be exposed from the upper side (e.g., the +Z-axis direction) of the upper holder body 320. The terminal 230 of the battery cell 20 may function as a first electrode terminal (e.g., the positive electrode terminal), and the terminal plate 222 may function as a second electrode terminal (e.g., a negative electrode).

The busbar body 400 disposed in the upper holder seating recess 321 may be connected to the terminal plate 222 and/or the terminal 230 exposed through the upper holder terminal hole 322, to connect the plurality of battery cells 20 in series, in parallel, and/or in series-parallel (i.e., a combination of series and parallel connections).

The upper holder terminal hole 322 may include a first electrode terminal hole 3221 and a second electrode terminal hole 3222.

The terminal 230 may be exposed from the upper side (e.g., the +Z-axis direction) of the upper holder body 320 through the first electrode terminal hole 3221, and the terminal plate 222 may be exposed from the upper side (e.g., the +Z-axis direction) of the upper holder body 320 through the second electrode terminal hole 3222.

A cross-sectional shape of the first electrode terminal hole 3221 may be generally circular. However, the cross-sectional shape of the first electrode terminal hole 3221 is not limited to a circular shape, and any suitable shape may be utilized.

The terminal 230 of the battery cell 20 may be moved from a lower portion (e.g., the −Z-axis direction) to an upper portion (e.g., the +Z-axis direction) of the first electrode terminal hole 3221 and inserted into the first electrode terminal hole 3221, and may be in contact with the first electrode terminal contact portion 401 of the busbar assembly 40.

An upper holder terminal rib 3221-1 and an upper holder terminal opening portion 3221-2 may be disposed in the first electrode terminal hole 3221.

The upper holder terminal rib 3221-1 may protrude in one direction (e.g., the +Z-axis direction) from the upper holder body 320 in the first electrode terminal hole 3221. Because the upper holder terminal rib 3221-1 is disposed in the first electrode terminal hole 3221, it is possible to prevent foreign substances from coming into contact with the terminal 230 and the busbar body 400, or substantially reduce the likelihood thereof.

The upper holder terminal opening portion 3221-2 may be defined as a portion in which the upper holder terminal rib 3221-1 is open. Because the upper holder terminal opening portion 3221-2 is formed, the busbar body 400 may be in contact with the terminal 230 through the upper holder terminal opening portion 3221-2.

A cross-sectional shape of the second electrode terminal hole 3222 may be an approximately quadrilateral shape. However, the cross-sectional shape of the second electrode terminal hole 3222 is not limited to the rectangular shape, and any suitable shape may be utilized.

The terminal plate 222 of the battery cell 20 may be moved from a lower portion (e.g., the −Z-axis direction) to an upper portion (e.g., the +Z-axis direction) of the second electrode terminal hole 3222 and in contact with the second electrode terminal contact portion 402 of the busbar assembly 40.

The busbar assembly 40 may include the first busbar assembly 40-1 and the second busbar assembly 40-2.

Each of the first busbar assembly 40-1 and the second busbar assembly 40-2 may connect the battery cells 20 in series, in parallel, and/or in series-parallel (i.e., a combination of series and parallel connections). The first busbar assembly 40-1 and the second busbar assembly 40-2 may be connected by the circuit board 50. According to some embodiments, the first busbar assembly 40-1 and the second busbar assembly 40-2 may be connected in series and/or in parallel.

Each of the first busbar assembly 40-1 and the second busbar assembly 40-2 may include the first electrode parallel busbar 41, the second electrode parallel busbar 42, and/or the series-parallel busbar 43.

The first electrode parallel busbar 41 may connect the first electrodes (e.g., the positive electrodes; terminals 230) of the plurality of battery cells 20 together (e.g., to be at the same voltage). According to some embodiments, the first electrode parallel busbar 41 may connect the terminals 230 of first electrode end battery cells 20-1 together (e.g., to be at the same voltage). For example, the first electrode parallel busbar 41 may connect the terminals 230 of the three first electrode end battery cells 20-1 together (e.g., to be at the same voltage).

The second electrode parallel busbar 42 may connect the second electrodes (e.g., negative electrodes, terminal plates 222) of the plurality of battery cells 20 together (e.g., to be at the same voltage). According to some embodiments, the second electrode parallel busbar 42 may connect the terminal plates 222 of the second electrode end battery cells 20-2 together (e.g., to be at the same voltage). For example, the second electrode parallel busbar 42 may connect the terminal plates 222 of three second electrode end battery cells 20-2 together (e.g., to be at the same voltage).

The series-parallel busbar 43 may connect the first electrodes and the second electrodes of the plurality of battery cells 20 in series, in parallel, or in series-parallel (i.e., a combination of series and parallel connections).

The series-parallel busbar 43 may connect the second electrodes of the first electrode end battery cells 20-1 together (e.g., to be at the same voltage), or connect the first electrodes of the second electrode end battery cells 20-2 together (e.g., to be at the same voltage).

The series-parallel busbar 43 may connect the second electrode of the first electrode end battery cell 20-1 and the first electrode of the series-parallel battery cell 20-3 in series, or connect the first electrode of the second electrode end battery cell 20-2 and the second electrode of the series-parallel battery cell 20-3 in series.

The series-parallel busbar 43 may connect the first electrode of the series-parallel battery cell 20-3 and the second electrode of the other series-parallel battery cell 20-3 in series.

Accordingly, the series-parallel busbar 43 may connect the plurality of battery cells 20 in series and in parallel.

The first electrode parallel busbar 41, the second electrode parallel busbar 42, and the series-parallel busbar 43 may have various suitable shapes. The shapes of the first electrode parallel busbar 41, the second electrode parallel busbar 42, and the series-parallel busbar 43 may be provided as ‘T,’ ‘C,’ ‘E,’ ‘I,’ ‘H,’ or the like.

According to some embodiments, the shape of the first electrode parallel busbar 41 may be a ‘C’ shape, the shape of the second electrode parallel busbar 42 may be a ‘T’ shape, and the shape of the series-parallel busbar 43 may be an ‘E’ shape.

The shapes of the first electrode parallel busbar 41, the second electrode parallel busbar 42, and the series-parallel busbar 43 are not limited to the examples above and any suitable shapes may be utilized.

The first electrode parallel busbar 41 may include a busbar body 400, a first electrode terminal contact portion 401, a board contact portion 403, and a bending portion 410.

The shape of the busbar body 400 may be provided as ‘T,’ ‘C,’ ‘E,’ ‘I,’ ‘H,’ or the like. The busbar body 400 may include a conductive material such as a metal. According to some embodiments, the busbar body 400 may include copper.

The first electrode terminal contact portion 401 may be disposed at an end of the busbar body 400. The first electrode terminal contact portion 401 may be in contact with and electrically connected to the terminal 230 of the battery cell 20. The first electrode terminal contact portion 401 may include a metal. According to some embodiments, the first electrode terminal contact portion 401 may include aluminum.

The bending portion 410 may be disposed between a plurality of first electrode terminal contact portions 401. According to some embodiments, the bending portion 410 may be disposed at a portion in which the busbar body 400 is bent. Accordingly, even when a distance between the terminals 230 changes due to a change in a volume of the battery cell 20 caused by swelling, it is possible to compensate for the change in the distance between the terminals 230 through deformation of the bending portion 410.

The board contact portion 403 may be disposed on the busbar body 400. The board contact portion 403 may be connected to the circuit board 50. Because the busbar body 400 and the circuit board 50 are in contact with each other by the board contact portion 403, information on the voltage, current, and temperature of the battery cells 20 connected to the busbar body 400 can be transferred to the circuit board 50.

The bending portion 410 may be disposed between the first electrode terminal contact portion 401 and the board contact portion 403. A height of one side 411 of the bending portion 410 disposed between the first electrode terminal contact portion 401 and the board contact portion 403 may be different from a height of the other side 412 of the bending portion.

The second electrode parallel busbar 42 may include a busbar body 400, a second electrode terminal contact portion 402, a board contact portion 403, and a bending portion 410.

The shape of the busbar body 400 may be provided as ‘T,’ ‘C,’ ‘E,’ ‘I,’ ‘H,’ or the like. The busbar body 400 may include a conductive material such as a metal. According to some embodiments, the busbar body 400 may include copper.

The second electrode terminal contact portion 402 may be disposed on a portion of the busbar body 400. The second electrode terminal contact portion 402 may include a metal. According to some embodiments, the second electrode terminal contact portion 402 may include copper.

The bending portion 410 may be disposed between a plurality of second electrode terminal contact portions 402. Accordingly, even when a distance between the terminal plates 222 changes due to a change in volume of the battery cell 20 caused by swelling, it is possible to compensate for the change in the distance between the terminal plates 222 through deformation of the bending portion 410.

The board contact portion 403 may be disposed on the busbar body 400. The board contact portion 403 may be connected to the circuit board 50. Because the busbar body 400 and the circuit board 50 are in contact with each other by the board contact portion 403, information on the voltage, current, and temperature of the battery cells 20 connected to the busbar body 400 can be transferred to the circuit board 50.

The bending portion 410 may be disposed between the second electrode terminal contact portion 402 and the board contact portion 403. A height of one side 411 of the bending portion 410 disposed between the second electrode terminal contact portion 402 and the board contact portion 403 may be different from a height of the other side 412 of the bending portion.

The series-parallel busbar 43 may include a busbar body 400, a first electrode terminal contact portion 401, a second electrode terminal contact portion 402, a board contact portion 403, and a bending portion 410.

The shape of the busbar body 400 may be provided as ‘T,’ ‘C,’ ‘E,’ ‘I,’ ‘H,’ or the like. The busbar body 400 may include a conductive material such as a metal. According to some embodiments, the busbar body 400 may include copper.

The first electrode terminal contact portion 401 may be disposed at an end of the busbar body 400. The first electrode terminal contact portion 401 may be in contact with and electrically connected to the terminal 230 of the battery cell 20. The first electrode terminal contact portion 401 may include a metal. According to some embodiments, the first electrode terminal contact portion 401 may include aluminum.

The second electrode terminal contact portion 402 may be disposed on a portion of the busbar body 400. The second electrode terminal contact portion 402 may include a metal. According to some embodiments, the second electrode terminal contact portion 402 may include copper.

The bending portion 410 may be disposed between a plurality of first electrode terminal contact portions 401. According to some embodiments, the bending portion 410 may be disposed at a portion in which the busbar body 400 is bent. Accordingly, even when a distance between the terminals 230 changes due to a change in a volume of the battery cell 20 caused by swelling, it is possible to compensate for the change in the distance between the terminals 230 through deformation of the bending portion 410.

The bending portion 410 may be disposed between a plurality of second electrode terminal contact portions 402. Accordingly, even when a distance between the terminal plates 222 changes due to a change in volume of the battery cell 20 caused by swelling, it is possible to compensate for the change in the distance between the terminal plates 222 through deformation of the bending portion 410.

The bending portion 410 may be disposed between the first electrode terminal contact portion 401 and the second electrode terminal contact portion 402. Accordingly, even when a distance between the terminal 230 of one battery cell 20 and the terminal plate 222 of another battery cell 20 changes due to a change in volume of the battery cell 20 caused by swelling, it is possible to compensate for the change in distance between the terminal plate 222 and the terminal 230 through deformation of the bending portion 410.

The board contact portion 403 may be disposed on the busbar body 400. The board contact portion 403 may be connected to the circuit board 50. Because the busbar body 400 and the circuit board 50 are in contact with each other by the board contact portion 403, information on the voltage, current, and temperature of the battery cells 20 connected to the busbar body 400 can be transferred to the circuit board 50.

The bending portion 410 may be disposed between the first electrode terminal contact portion 401 and/or the second electrode terminal contact portion 402 and the board contact portion 403. A height of one side 411 of the bending portion 410 disposed between the first electrode terminal contact portion 401 and/or the second electrode terminal contact portion 402 and the board contact portion 403 may be different from a height of the other side 412 of the bending portion.

The busbar body 400 may include the bending portion 410 that is configured to be bent. Because the bending portion 410 is formed in the busbar body 400, a length thereof may change with the change in volume of the battery cell 20 caused by swelling. The bending portion 410 may have an approximately U-shaped form.

The bending portion 410 may include the one side 411 of the bending portion and the other side 412 of the bending portion. According to some embodiments, the height of the one side 411 of the bending portion may be the same as or different from the height of the other side 412 of the bending portion. The other side 412 of the bending portion may be disposed closer to the first electrode terminal contact portion 401 than the one side 411 of the bending portion. According to some embodiments, the height (e.g., the Z-axis direction) of the other side 412 of the bending portion may be lower than the height (e.g., the Z-axis direction) of the one side 411 of the bending portion.

The bending portion 410 may include a bending bridge 413. The bending bridge 413 may be defined as a portion that protrudes upward (e.g., in the +Z-axis direction) in the bending portion 410. Because the bending bridge 413 protrudes upward, the bending recess portion 414 may be formed below the bending bridge 413 (e.g., in the −Z-axis direction).

The upper holder seating projection 3211 of the upper holder 32 may be inserted into the bending recess portion 414. Accordingly, the busbar body 400 may be fixed to the upper holder 32. Further, a location where the busbar body 400 is disposed may be guided by the bending recess portion 414 and the upper holder seating projection 3211.

Bending slits 415 will be described with reference to FIGS. 15 to 20.

The circuit board 50 may include a circuit board body 500, a circuit board connection portion 501, and a connection guide portion 502.

The circuit board body 500 may extend in one direction (e.g., the Y-axis direction). The circuit board body 500 may have an approximately hexahedral shape. The circuit board connection portion 501 connected to the busbar body 400 may be disposed in the circuit board body 500. According to some embodiments, the circuit board connection portion 501 may be disposed at both sides (e.g., in the X-axis direction) of the circuit board body 500. The circuit board connection portion 501 may be connected to the board contact portion 403 of the busbar body 400.

The circuit board connection portion 501 may include a conductive material. According to some embodiments, the circuit board connection portion 501 may include copper.

Because the circuit board connection portion 501 is in contact with and is electrically connected to the board contact portion 403, the circuit board 50 may receive information (e.g., voltage, current, temperature) of the battery cell 20.

The connection guide portion 502 may be disposed in the circuit board body 500. The connection guide portion 502 may extend from the circuit board body 500 toward the circuit board connection portion 501. According to some embodiments, the connection guide portion 502 may extend parallel to one direction (e.g., the Y-axis direction) from the circuit board body 500 toward the circuit board connection portion 501.

The board contact portion 403 may be disposed between the connection guide portion 502 and the circuit board connection portion 501. The board contact portion 403 may be pressed downward (e.g., in the −Z-axis direction) by the connection guide portion 502. Accordingly, the board contact portion 403 may be in close contact with the circuit board connection portion 501. The board contact portion 403 and the circuit board connection portion 501 may be coupled by welding or the like.

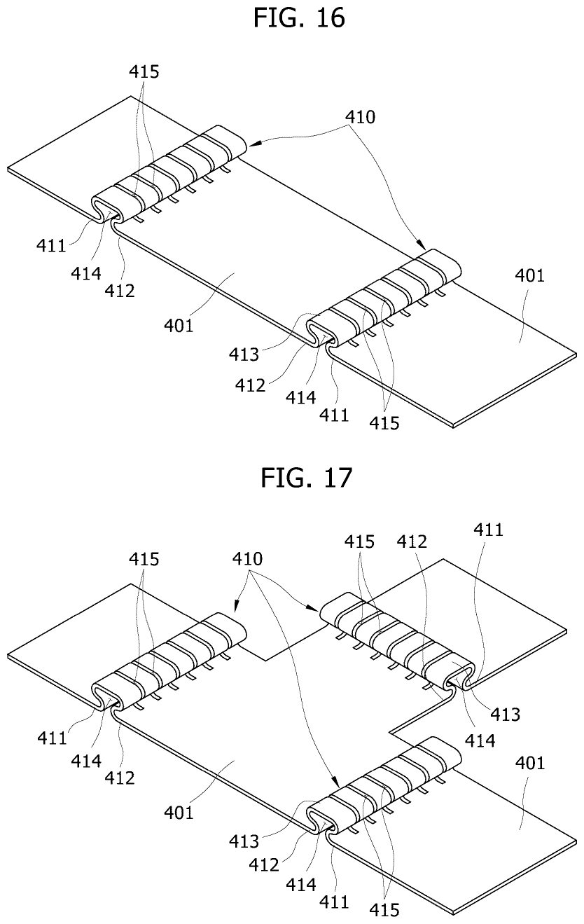

FIG. 15 is a perspective view of the first electrode terminal contact portion according to the present disclosure. FIG. 16 is a perspective view of the first electrode terminal contact portion according to some other embodiments of the present disclosure. FIG. 17 is a perspective view of the first electrode terminal contact portion according to still other embodiments of the present disclosure.

Various embodiments of the first electrode terminal contact portion 401 can be seen with reference to FIGS. 15 to 17.

The first electrode terminal contact portion 401 illustrated in FIG. 15 is the first electrode terminal contact portion 401 disposed at the end of the first electrode parallel busbar 41 illustrated in FIG. 12 according to some embodiments and the first electrode terminal contact portion 401 disposed at the end of the series-parallel busbar 43 illustrated in FIG. 14 according to some embodiments.

The first electrode terminal contact portion 401 illustrated in FIG. 16 is the first electrode terminal contact portion 401 disposed at a center of the first electrode parallel busbar 41 illustrated in FIG. 12 according to some embodiments.

The first electrode terminal contact portion 401 illustrated in FIG. 17 is the first electrode terminal contact portion 401 disposed at a center of the series-parallel busbar 43 illustrated in FIG. 14 according to some embodiments.

The first electrode terminal contact portion 401 may connect the busbar body 400 and the terminal 230 of the battery cell 20. According to some embodiments, the first electrode terminal contact portion 401 may connect the busbar body 400 and the terminal 230 of the first electrode end battery cell 20-1.

The first electrode terminal contact portion 401 may include a different metal from the busbar body 400. According to some embodiments, the busbar body 400 may include copper, and the first electrode terminal contact portion 401 may include aluminum.

A thickness of the busbar body 400 may be about 0.1 mm to about 0.5 mm. According to some embodiments, the thickness of the busbar body 400 may be about 0.3 mm.

A thickness of the first electrode terminal contact portion 401 may be about 0.2 mm to about 0.6 mm. According to some embodiments, the thickness of the first electrode terminal contact portion 401 may be about 0.4 mm. Because the thickness of the first electrode terminal contact portion 401 to be branched is larger than that of the busbar body 400, a bottleneck phenomenon in the first electrode terminal contact portion 401 can be reduced.

The first electrode terminal contact portion 401 illustrated in FIG. 15 may be connected to one busbar body 400 without being branched according to some embodiments.

The first electrode terminal contact portion 401 of the embodiments illustrated in FIG. 16 may be branched and connected to two busbar bodies 400.

The first electrode terminal contact portion 401 illustrated in FIG. 17 may be branched and connected to three busbar bodies 400.

Referring to FIGS. 15 to 17, the bending portion 410 may be connected to the first electrode terminal contact portion 401. According to some embodiments, the bending portion 410 may be formed integrally with the first electrode terminal contact portion 401.

The other side 412 of the bending portion 410 may be disposed closer to the terminal 230 than the one side 411 of the bending portion.

The bending portion 410 may include the bending bridge 413, and the bending bridge 413 may be bent to protrude to one side (e.g., in the +Z-axis direction). Because the bending bridge 413 is bent to protrude to the one side, the bending recess portion 414 may be formed in a direction opposite to the direction in which the bending bridge 413 protrudes. The upper holder seating projection 3211 may be inserted into the bending recess portion 414.

The bending slits 415 formed as holes may be disposed in the bending bridge 413. The bending slits 415 may be elongated holes formed from the one side 411 of the bending portion to the other side 412 of the bending portion.

Because the bending slits 415 are formed in the bending bridge 413, an amount of a current that can flow in the bending bridge 413 can be reduced, and the bending bridge 413 in which the bending slits 415 are formed can perform a function of a fuse. Accordingly, the safety of the battery cells 20 and the battery pack 1 can be improved (e.g., increased).

A length of the bending bridge 413 may be about 2.0 mm to about 10.0 mm.

One or more bending slits 415 formed in the bending bridge 413 may be provided.

A width of the bending slit 415 may be about 0.5 mm to about 1.5 mm. According to some embodiments, a width of the bending slit 415 may be about 0.8 mm.

A spacing between the adjacent bending slits 415 may be about 0.8 mm to about 5.0 mm. According to some embodiments, the spacing between the adjacent bending slits 415 may be about 1.0 mm or more.

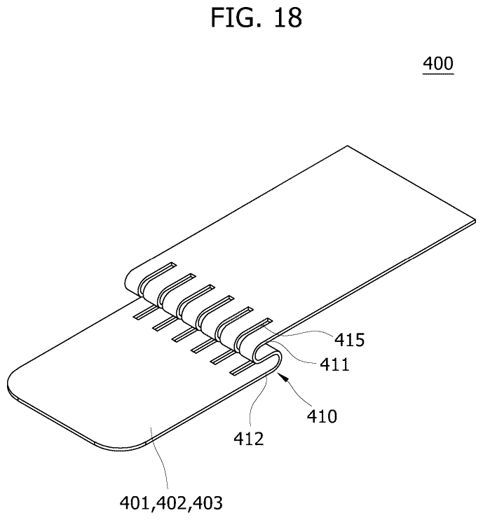

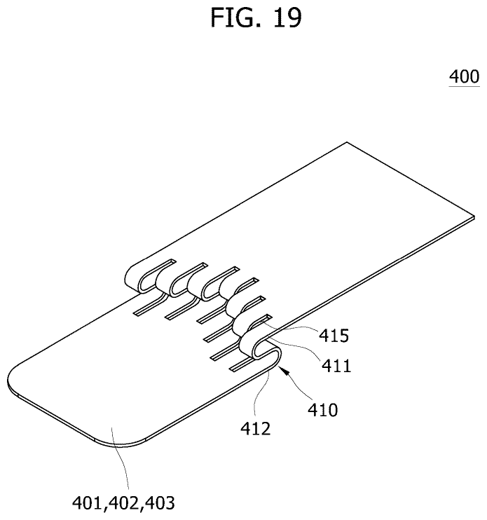

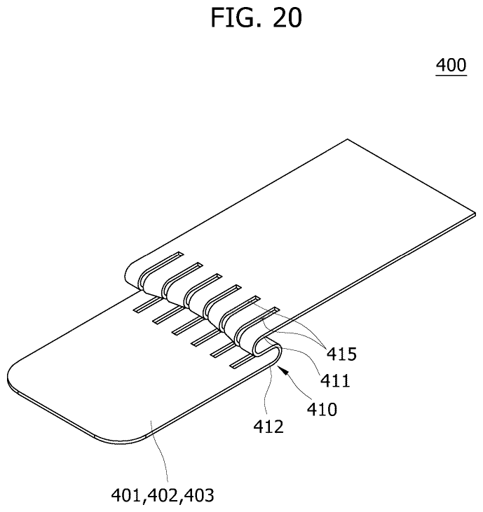

FIG. 18 is a perspective view of the bending portion of the busbar assembly according to the present disclosure. FIG. 19 is a perspective view of the bending portion of a busbar assembly according to some other embodiments of the present disclosure. FIG. 20 is a perspective view of a bending portion of the busbar assembly according to still other embodiments of the present disclosure.

Various embodiments of the bending portion 410 can be seen with reference to FIGS. 18 to 20. The heights of the one side 411 and the other side 412 of the bending portion 410 illustrated in FIGS. 18 to 20 may be different. According to some embodiments, the height of the one side 411 of the bending portion may be higher than the height of the other side 412 of the bending portion.

Referring to FIGS. 18 to 20, a plurality of bending slits 415 may be provided in the bending portion 410.

Referring to FIG. 18, a portion of the bending portion 410 protruding toward the first electrode terminal contact portion 401, the second electrode terminal contact portion 402, and/or the board contact portion 403 may be disposed perpendicular to a longitudinal direction of the busbar body 400.

Referring to FIG. 19, the portion of the bending portion 410 protruding toward the first electrode terminal contact portion 401, the second electrode terminal contact portion 402, and/or the board contact portion 403 may be disposed in a ‘V’ shape with respect to the longitudinal direction of the busbar body 400.

Referring to FIG. 20, the portion of the bending portion 410 protruding toward the first electrode terminal contact portion 401, the second electrode terminal contact portion 402, and/or the board contact portion 403 may have a curved shape with respect to the longitudinal direction of the busbar body 400.

Thus, even when the spacing between the battery cells 20 changes, the bending portion 410 can compensate for the change in the spacing between the battery cells 20.

Further, even when the terminal plate 222, the terminal 230, and/or the circuit board connection portion 501 has a different height, it is possible to improve (e.g., increase) the flatness of a welding surface because the height of the one side 411 of the bending portion 410 is different from the height of the other side 412 of the bending portion.

In the busbar assembly 40 and the battery pack 1 including the same according to some embodiments of the present disclosure, it is possible to compensate for a difference in height between the electrode terminals of the battery cells 20.

Further, in the busbar assembly 40 and the battery pack 1 including the same according to some embodiments of the present disclosure, it is possible to improve the flatness of the welding surface (e.g., the terminal 230 and the terminal plate 222) of the battery cell 20.

In the busbar assembly and the battery pack including the same according to some embodiments of the present disclosure, it is possible to compensate for a difference in height between terminals of battery cells.

In the busbar assembly and the battery pack including the same according to some embodiments of the present disclosure, it is possible to improve (e.g., increase) the flatness of a welding surface of a battery cell.

While the present disclosure has been described with reference to embodiments shown in the drawings, these embodiments are merely illustrative and it should be understood that various suitable modifications and equivalent other embodiments can be derived by those skilled in the art on the basis of the embodiments described above.

Therefore, the technical scope of the present disclosure should be defined by the appended claims and equivalents thereof.

What is claimed is:

1. A busbar assembly comprising:
a first electrode parallel busbar configured to connect first electrode terminals of a plurality of first electrode end battery cells among a plurality of battery cells, each one of the battery cells comprising a first electrode terminal of the first electrode terminals and a second electrode terminal of the second electrode terminals;
a second electrode parallel busbar configured to connect the second electrode terminals of a plurality of second electrode end battery cells among the plurality of battery cells; and
a series-parallel busbar configured to connect the second electrode terminals of the plurality of battery cells of which the first electrode terminals are connected together among the plurality of battery cells and the first electrode terminals of the plurality of battery cells of which the second electrode terminals are connected together among the plurality of battery cells.

2. The busbar assembly as claimed in claim 1, wherein the series-parallel busbar is connected to the second electrode terminals of the first electrode end battery cells.

3. The busbar assembly as claimed in claim 1, wherein the series-parallel busbar is connected to the first electrode terminals of the second electrode end battery cells.

4. The busbar assembly as claimed in claim 1, wherein the series-parallel busbar comprises a first series-parallel busbar and a second series-parallel busbar, and
wherein the first series-parallel busbar connects together the first electrode terminals of the battery cells of which the second electrode terminals are connected together by the second series-parallel busbar.

5. The busbar assembly as claimed in claim 1, wherein the first electrode parallel busbar, the second electrode parallel busbar, and the series-parallel busbar comprise a board contact portion connected to a circuit board.

6. The busbar assembly as claimed in claim 1, wherein the first electrode parallel busbar and the series-parallel busbar comprise a first electrode terminal contact portion that is in contact with the first electrode terminal and comprises a first metal, and
wherein the second electrode parallel busbar and the series-parallel busbar comprise a second electrode terminal contact portion that is in contact with the second electrode terminal and comprises a second metal different from the first metal.

7. The busbar assembly as claimed in claim 1, wherein at least one of the first electrode parallel busbar, the second electrode parallel busbar, and the series-parallel busbar comprises:
a busbar body; and
a bending portion in the busbar body and formed to be bent between one side of the bending portion and an other side of the bending portion.

8. The busbar assembly as claimed in claim 7, wherein a height of one side of the bending portion is different from a height of the other side of the bending portion.

9. The busbar assembly as claimed in claim 7, wherein the bending portion further comprises:
a bending bridge on the busbar body and formed to be concave; and
a bending slit formed as a hole passing through the bending bridge.

10. The busbar assembly as claimed in claim 9, wherein the first electrode parallel busbar connects the first electrode end battery cells together,
wherein the second electrode parallel busbar connects the second electrode end battery cells together, and
wherein the series-parallel busbar connects the battery cells in parallel.

11. A battery pack comprising:
a holder part comprising a lower holder and an upper holder;
a first group battery cell between the lower holder and the upper holder and comprising a plurality of battery cells each comprising a first electrode terminal and a second electrode terminal; and
a first busbar assembly disposed in the upper holder to electrically connect the battery cells in the first group battery cell,
wherein the first busbar assembly comprises:
a first electrode parallel busbar configured to connect the first electrode terminals of a plurality of first electrode end battery cells among the plurality of battery cells together;
a second electrode parallel busbar configured to connect the second electrode terminals of a plurality of second electrode end battery cells among the plurality of battery cells together; and
a series-parallel busbar configured to connect the second electrode terminals of the plurality of battery cells of which the first electrode terminals are connected together among the plurality of battery cells, and the first electrode terminals of the plurality of battery cells of which the second electrode terminals are connected together among the plurality of battery cells.

12. The battery pack as claimed in claim 11, further comprising:
a second group battery cell between the lower holder and the upper holder and comprising a plurality of battery cells each comprising a first electrode terminal and a second electrode terminal; and
a second busbar assembly in the upper holder to electrically connect the battery cells of the second group battery cell and comprising a first electrode parallel busbar, a second electrode parallel busbar, and a series-parallel busbar.

13. The battery pack as claimed in claim 12, further comprising:
a circuit board in the upper holder and comprising a circuit board connection portion to which the first busbar assembly and the second busbar assembly are connected, and configured to connect the first busbar assembly and the second busbar assembly in series.

14. The battery pack as claimed in claim 12, wherein the upper holder comprises:
an upper holder body; and
an upper holder seating recess formed as a concave recess in the upper holder body in which the first busbar assembly and the second busbar assembly are positioned.

15. The battery pack as claimed in claim 14, wherein the upper holder further comprises an upper holder seating projection in the upper holder seating recess, protruding from the upper holder body, and inserted into a bending recess portion formed to be concave in the first busbar assembly or the second busbar assembly.

16. The battery pack as claimed in claim 12, wherein the upper holder comprises:
an upper holder body; and
an upper holder terminal hole that passes through the upper holder body and exposes one of the battery cells.

17. The battery pack as claimed in claim 11, wherein at least one of the first electrode parallel busbar, the second electrode parallel busbar, and the series-parallel busbar comprises:
a busbar body; and
a bending portion disposed in the busbar body and formed to be bent between one side and an other side of the bending portion.

18. The battery pack as claimed in claim 17, wherein a height of one side of the bending portion is different from a height of the other side of the bending portion.

19. The battery pack as claimed in claim 17, wherein the bending portion further comprises:
a bending bridge on the busbar body and formed to be concave; and
a bending slit formed as a hole passing through the bending bridge.

20. The battery pack as claimed in claim 19, wherein the first electrode parallel busbar connects the first electrode end battery cells together,
wherein the second electrode parallel busbar connects the second electrode end battery cells together, and
wherein the series-parallel busbar connects the battery cells in parallel.
